(19) United States
(12) Patent Application Publication
(10) Pub. No.: US 2009/0247354 A1
(43) Pub. Date: Oct. 1, 2009

(54) METHOD FOR CONTROLLING AN ELECTROMAGNETIC RETARDER

(76) Inventors: Bruno Dessirier, Saint Germain en Laye (FR); Stephane Hailly, Issy Les Moulineaux (FR); Serge Newiadomy, Clichy Sous Bois (FR)

Correspondence Address: BERENATO, WHITE & STAVISH, LLC, 6550 ROCK SPRING DRIVE, SUITE 240, BETHESDA, MD, 20817, US

(21) Appl. No.: 12/092,148

(22) PCT Filed: Dec. 15, 2006
(86) PCT No.: PCT/FR2006/002751

§ 371 Date: Nov. 25, 2008

(30) Foreign Application Priority Data
Dec. 22, 2005 (FR) 0554046

(51) Int. Cl. H02P 15/00

(52) U.S. Cl. 477/23

(57) ABSTRACT

A method for controlling an electromagnetic retarder comprising a current generator into which an excitation current is injected. The method consists in determining a maximum allowable intensity (Im) of the excitation current to be injected into the stator primary coils of the retarder which includes a shaft bearing secondary windings and field coils which are supplied by the secondary windings, said primary coils and secondary windings forming the generator. The retarder includes a jacket inside which the field coils generate Foucault currents and a circuit for the liquid cooling of said jacket. More specifically, the method consists in determining the maximum allowable intensity in real time, such as to reach a critical temperature of the cylindrical jacket and determining said critical temperature taking account of a temperature value of the coolant. The method is suitable for retarders that are intended for vehicles such as heavy vehicles.

### FIELD OF THE INVENTION

The invention concerns a method of controlling an electromagnetic retarder comprising a current generator.

The invention applies to a retarder capable of generating a retarding resisting torque on a main or secondary transmission shaft of a vehicle that it equips, when this retarder is actuated.

### PRIOR ART

Such an electromagnetic retarder comprises a rotary shaft that is coupled to the main or secondary transmission shaft of the vehicle in order to exert on it the retarding resisting torque in particular for assisting the braking of the vehicle.

The retarding is generated with field coils supplied with DC current in order to produce a magnetic field in a metal piece made from ferromagnetic material, in order to make eddy currents appear in this metal piece.

The field coils can be fixed so as to cooperate with at least one metal piece made from movable ferromagnetic material having the general appearance of a disc rigidly secured to the rotary shaft.

In this case, these field coils are generally oriented parallel to the rotation axis and disposed around this axis, facing the disc, while being secured to a fixed plate. Two successive field coils are supplied electrically in order to generate magnetic fields in opposite directions.

When these field coils are supplied electrically, the eddy currents that they generate in the disc through their effects oppose the cause that gave rise to them, which produces a resisting torque on the disc and therefore on the rotary shaft, in order to slow down the vehicle.

In this embodiment, the field coils are supplied electrically by a current coming from the electrical system of the vehicle, that is to say for example from a battery of the vehicle. However, in order to increase the performance of the retarder, recourse is had to a design in which a current generator is integrated in the retarder.

Thus, according to another design known from the patent documents EP0331559 and FR1467310, the electrical supply to the field coils is provided by a generator comprising primary stator coils supplied by the vehicle system, and secondary rotor coils fixed to the rotating shaft.

The field coils are then fixed to the rotating shaft while being radially projecting, so that they turn with the rotary shaft in order to generate a magnetic field in a fixed cylindrical jacket that surrounds them.

A rectifier such as a diode bridge rectifier is interposed between the secondary rotor windings of the generator and the field coil, in order to convert the alternating current delivered by the secondary windings of the generator into a DC current supplying the field coils.

Two radial field coils consecutive around the rotation axis generate magnetic fields in opposite directions, one generating a field oriented centrifugally, the other a field oriented centripetally.

In operation, the electrical supply to the primary coils enables the generator to produce the supply current to the field coils, which gives rise to eddy currents in the fixed cylindrical jacket so as to generate a resisting torque on the rotary shaft, which slows the vehicle.

In order to reduce the weight and increase further the performance of such a retarder, it is advantageous to couple it to the transmission shaft of the vehicle by means of a speed multiplier, in accordance with the solution adopted in the patent document EP1527509.

The rotation speed of the retarder shaft is then multiplied compared with the rotation speed of the transmission shaft to which it is coupled. This arrangement significantly increases the electrical power delivered by the generator and therefore the power of the retarder.

### OBJECT OF THE INVENTION

The aim of the invention is a method of determining the maximum acceptable intensity of the excitation current of the primary coils of an electromagnetic retarder for improving its performance and reliability.

To this end, an object of the invention is a method for determining, in a control box, a maximum acceptable intensity of an excitation current to be injected into primary stator coils of an electromagnetic retarder comprising a rotary shaft carrying secondary windings and field coils supplied electrically by these secondary windings, the primary coils and the secondary windings forming a generator, this retarder comprising a fixed cylindrical jacket surrounding the field coils and in which the field coils generate eddy currents, and a liquid-circulation cooling circuit for this jacket, this method consisting of determining the maximum acceptable intensity in real time, so that this maximum acceptable intensity corresponds to a critical temperature of the cylindrical jacket, and determining this critical temperature by taking into account a temperature level of the cooling liquid.

The taking into account of the temperature of the cooling liquid makes it possible to increase the critical temperature of the fixed cylindrical jacket, in particular when the cooling liquid has a temperature that is low. The increase in critical temperature of the jacket makes it possible to increase accordingly the intensity of the excitation current, and thereby the retarding torque generated by the retarder.

The invention also concerns a method as defined above in which the temperature of the cooling liquid corresponds to a measurement value issuing from a temperature probe situated at the outlet from the cooling circuit.

The invention also concerns a method as defined above, consisting of taking into account the flow rate of the cooling liquid in order to determine the critical temperature.

The invention also concerns a method as defined above in which the maximum acceptable intensity is determined in the control box from tables of numerical values stored in this control box, these tables comprising values representing the maximum acceptable current for different operating conditions.

The invention also concerns a method as defined above, consisting of determining the value representing the flow rate of cooling liquid from the speed of a thermal engine of the vehicle and a nomogram characteristic of a water pump driven by this thermal engine, this water pump causing the circulation of the cooling liquid.

The invention also concerns a method as defined above, in which the value signifying the speed of the thermal engine issues from data transmitted by a CAN bus.

### BRIEF DESCRIPTION OF THE DRAWINGS

The invention will now be described in more detail and with reference to the accompanying drawings, which illustrate an embodiment thereof by way of non-limitative example.

FIG. 1 is an overall view with a local cutaway of an electromagnetic retarder to which the invention applies;

FIG. 2 is a schematic representation of the electrical components of the retarder for which the method according to the invention is intended;

FIG. 3 is a curve representing the intensity of the excitation current according to the speed of rotation of the rotary shaft in order to obtain a current flowing in the field coils having a constant intensity;

FIG. 4 is a curve representing the critical temperature of the cylindrical jacket as a function of the flow rate of cooling liquid;

FIG. 5 is a curve representing the increase in the critical temperature as a function of the temperature of the cooling liquid;

FIG. 6 comprises two curves for the intensity of the current injected into the primary coils as a function of the temperature of the cylindrical jacket for two temperatures of the cooling liquid.

### DESCRIPTION OF EMBODIMENTS OF THE INVENTION

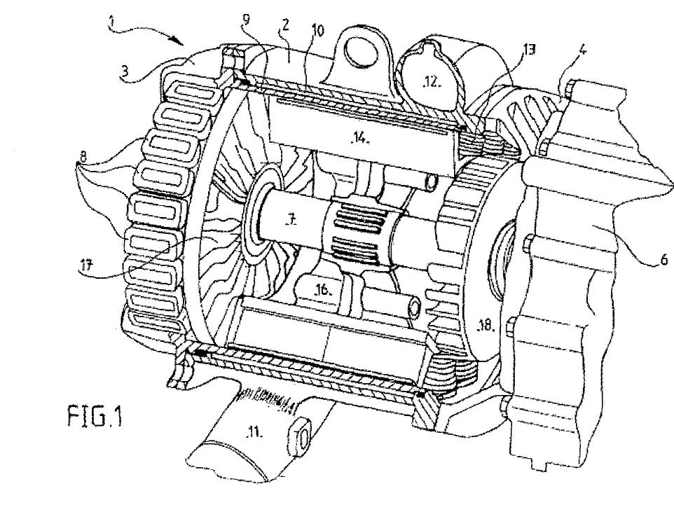

In FIG. 1, the electromagnetic retarder 1 comprises a main casing 2 with a cylindrical shape overall having a first end closed by a cover 3 and a second end closed by a coupling piece 4 by means of which this retarder 1 is fixed to a gearbox casing either directly or indirectly, here via a speed multiplier referenced 6.

This casing 2, which is fixed, encloses a rotary shaft 7 that is coupled to a transmission shaft, not visible in the figure, such as a main transmission shaft to the vehicle wheels, or secondary such as a secondary gearbox output shaft via the speed multiplier 6. In a region corresponding to the inside of the cover 3 a current generator is situated, which comprises fixed or stator primary coils 8 that surround rotor secondary windings, secured to the rotary shaft 7.

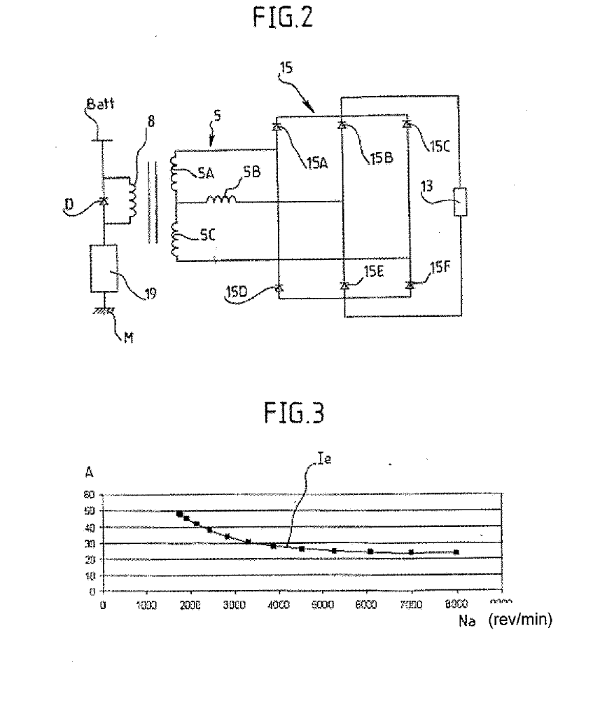

These secondary windings are shown symbolically in FIG. 2, being marked by the reference 5. These secondary windings 5 comprise here three distinct windings 5A, SB and 5C in order to deliver a three-phase alternating current having a frequency dependent on the speed of rotation of the rotary shaft 7.

A fixed internal jacket 9, cylindrical in shape overall, is mounted in the main casing 2, being slightly spaced apart radially from the external wall of this main casing 2 in order to define a substantially cylindrical intermediate space 10 in which a cooling liquid of this jacket 9 circulates.

This main casing, which also has a cylindrical shape overall, is provided with a channel 11 for admitting cooling liquid into the space 10 and a channel 12 for discharging cooling liquid out of this space 10.

The cooling circuit of the retarder can be connected in series with the cooling circuit of the thermal engine of the vehicle that this retarder equips. In this case, the inlet 11 is connected to the outlet of the thermal engine, the outlet 12 being connected to the inlet of a cooling radiator of this circuit.

This jacket 9 surrounds several field coils 13, which are carried by a rotor 14 rigidly fixed to the rotary shaft 7. Each field coil 13 is oriented so as to generate a radial magnetic field while having an oblong shape overall extending parallel to the shaft 7.

In a known fashion, the jacket 9 and the body of the rotor 14 are made from ferromagnetic material. Here the casing is a castable piece based on aluminium and sealing joints intervene between the casing and jacket 9; the cover 3 and the piece 4 are perforated.

The field coils 13 are supplied electrically by the rotor secondary windings 5 of the generator via a bridge rectifier carried by the rotary shaft 7. This bridge rectifier can be the one that is marked 15 in FIG. 2 and that comprises six diodes 15A-15F, in order to rectify the three-phase alternating current issuing from the secondary windings 5A-5D into direct current. This bridge rectifier can also be of another type, being for example formed from transistors of the MOSFET type.

As can be seen in FIG. 1, the rotor 14 carrying the field coils 13 has the overall shape of a hollow cylinder connected to the rotary shaft 7 by radial arms 16. This rotor 14 thus defines an annular internal space situated around the shaft 7, this internal space being ventilated by an axial fan 17 situated substantially in line with the junction of the cover 3 with the casing 2. A radial fan 18 is situated at the opposite end of the casing 2 in order to discharge the air introduced by the fan 17.

The action on the retarder consists of supplying the primary coils 8 with an excitation current coming from the electrical system of the vehicle and in particular the battery, so that the generator delivers a current at its secondary windings 5. This current delivered by the generator then supplies the field coils 13 so as to generate eddy currents in the fixed cylindrical jacket 9 in order to produce a resisting torque providing the retarding of the vehicle. The excitation current is injected into the primary coils 8 by means of a control box described below.

The electric power delivered by the secondary windings 5 of the generator is greater than the electric power supplying the primary coils 8 since it is the result of the magnetic field of the primary coils 8 and the work supplied by the rotary shaft. In the embodiment in FIG. 1, the shaft 7 of the retarder is connected to the transmission shaft of the vehicle wheels via the multiplier 6 acting on a secondary shaft of the gearbox connected to the main shaft thereof.

This retarder comprises a control box 19 shown in FIG. 2, which is interposed for example between an electrical supply source of the vehicle, and the primary coils 8. In the example in FIG. 2, the control box 19 and the primary coils 8 are connected in series between an earth M of the vehicle and a supply Batt of the vehicle battery. As can be seen in this figure, a diode D is connected to the terminals of the primary coils 8 so as to prevent the circulation of a reverse current in the primary coils.

The control box 19 of the retarder is an electronic box comprising for example a logic circuit of the ASIC type functioning at 5V, and/or a power control circuit capable of managing high-intensity currents.

This control box 19 comprises an input able to receive a control signal for the retarder, this signal representing a level of retarding torque demanded of the retarder. The control box 19 determines in real time a maximum intensity Im acceptable for the current to be injected into the primary coils 8. It next defines the intensity le of the excitation current, from the maximum intensity Im and the value taken by the control signal.

The maximum acceptable intensity lm of the excitation current le to be injected into the primary coils is determined in real time in the control box 19 from data and measurements representing the temperature of the cooling liquid at the outlet 12, denoted Tr, and the flow rate of the cooling liquid, denoted D.

The intensity Im is a threshold value beyond which the temperature of the cylindrical jacket 9 is too high and causes the cooling liquid to start to boil, even if this circuit is capable of discharging the heat output resulting from the eddy currents flowing in this jacket.

If the temperature if the jacket is situated beyond the critical temperature Tc, the cooling liquid starts to boil, which quickly causes the ruin of the electromagnetic retarder.

The temperature of the cylindrical jacket depends mainly on the intensity of the eddy currents flowing in the cylindrical jacket 9. This is directly related to the intensity of the current, denoted If, that flows in the field coils 13. This current If itself has an intensity dependent on the rotation speed Na of the rotary shaft 7 and the intensity of the excitation current Ie. In other words, for a constant intensity of the current If flowing in the field coils 13, the excitation current Ie injected into the primary coils 8 must decrease when the rotation speed Na of the rotary shaft 7 increases, as shown schematically in FIG. 3.

The rotation speed Na of the rotary shaft 7 can come from a rotation speed sensor equipping the retarder, or be derived from data available on a CAN bus of the vehicle to which the box 19 is connected. In this case, the speed multiplying factor 6 is stored in the control box 19 to enable the speed Na to be determined from the data of the CAN bus.

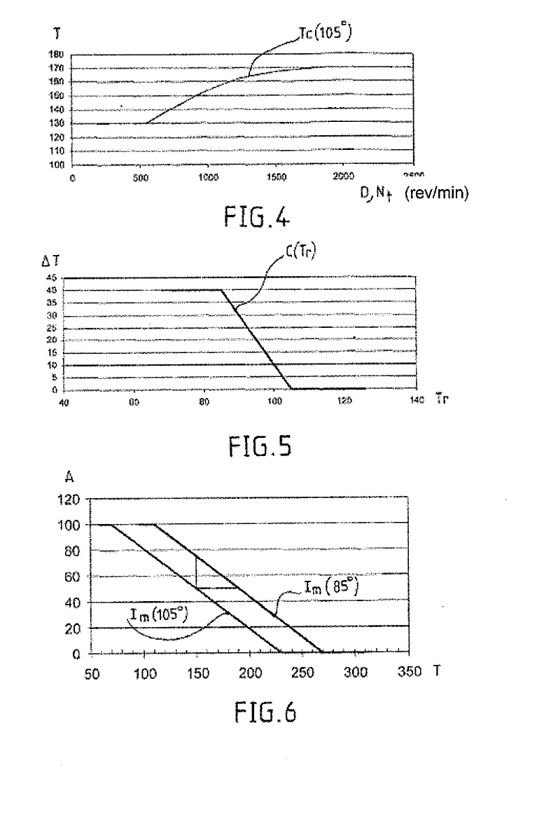

FIG. 4 is a graph representing the critical temperature Tc(105°) as a function of the flow rate D of cooling liquid, for a cooling liquid having a temperature Tr equal to 105°. As this graph shows, the higher the rate D, the higher the critical temperature Tc may be.

The flow rate D of cooling liquid depends on the rotation speed of a water pump driven by the thermal engine of the vehicle and which causes the circulation of the cooling liquid. This rate results from the speed of rotation of the thermal engine, denoted Nt, and a nomogram representing the characteristic of this pump. Advantageously, the control box 19 recovers on the CAN bus the rotation speed Nt in order to determine the rate D from the nomogram of the pump stored in this control box 19.

The critical temperature Tc is in fact also dependent on the temperature Tr of the cooling liquid: it can be all the higher, the lower the temperature Tr of the cooling liquid, and this without any risk of the cooling liquid starting to boil.

FIG. 5 is a graph representing the correction C(Tr) to be applied to the temperature Tc(105°) of the graph in FIG. 4 in order to take into account the temperature Tr of the cooling liquid at the outlet 12 from the cooling circuit. As can be seen in this graph, when the temperature Tr is equal to eighty five degrees, the critical temperature Tc issuing from the graph in FIG. 4 can be increased by forty five degrees. The correction C(Tr) to be applied is zero when Tr is greater than or equal to one hundred and five degrees.

The use of the data shown in the graphs in FIGS. 4 and 5 makes it possible to determine the critical temperature Tc as a function of the rate D, that is to say the rotation speed Nt of the thermal engine and the temperature Tr of the cooling liquid, at the outlet 12 from the cooling circuit.

To do this, numerical data corresponding to the graphs in FIGS. 4 and 5 are stored in the control box. The determination of Tc consists first of all of reading in a first table, from the rate D, or the rotation speed Nt of the thermal engine, the critical temperature for one hundred and five degrees: Tc(105°). Next, the correction C(Tr) to be applied is read in another data table corresponding to FIG. 5, and is added to the temperature Tc(105°). Thus Tc=Tc(105°)+C(Tr).

The determination of the maximum acceptable intensity Im consists of identifying first of all a threshold value of the current If flowing in the field coils beyond which the heat output generated by the eddy currents issuing from If would cause a temperature rise in the cylindrical jacket beyond the critical temperature Tc.

From this threshold value of the current If flowing in the field coils, and the rotation speed Na of the rotary shaft 7, the maximum intensity Im of the excitation current is read in another data table. This other data table represents the current If as a function of the excitation current le and the rotation speed Na of the rotary shaft 7.

The correction C(Tr) makes it possible to increase the operating temperature of the cylindrical jacket, by an additional forty degrees in the most favourable cases. This increase in temperature allows a significant increase in the intensity Im of the current injected and therefore the retarding torque that the retarder is capable of supplying.

FIG. 6 is a graph giving the maximum acceptable intensity for the excitation current, as a function of the temperature of the jacket. The maximum acceptable intensity is shown by a curve marked Im(105°) in the case of a cooling liquid having a temperature Tr of one hundred and five degrees, and is represented by another curve marked Im(85°) corresponding to a case in which the temperature of the cooling liquid is equal to eighty five degrees, which makes it possible to increase the critical temperature Tc by forty degrees.

An increase of forty degrees in the critical temperature Tc can correspond to an increase in the maximum intensity ranging up to seventy five percent.

In the embodiment presented above, the data are stored in the form of independent data tables, but these data can also be stored in the control box 19 in the form of one or more two-way dynamic tables.

This facilitates implementation of the control method according to the invention whilst offering flexibility affording adaptability to different use contexts.

1. Method for determining, in a control box, a maximum acceptable intensity (Im) of an excitation current (Ie) to be injected into primary stator coils (8) of an electromagnetic retarder (1) comprising a rotary shaft (7) carrying secondary windings (5) and field coils (13) supplied electrically by said secondary windings (5), the primary coils (8) and the secondary windings (5) forming a generator, said retarder (1) comprising a fixed cylindrical jacket (9) surrounding the field coils 13) and in which the field coils (13) generate eddy currents, and a liquid-circulation cooling circuit for this jacket, said method comprising the steps of:
determining the maximum acceptable intensity (Im) in real time, so that said maximum acceptable intensity corresponds to a critical temperature (Tc) of the cylindrical jacket (9), and
determining said critical temperature (Te) by taking into account a temperature level (Tr) of the cooling liquid.

2. Method according to claim 1, in which the temperature (Tr) of the cooling liquid corresponds to a measurement value issuing from a temperature probe situated at the outlet (12) from the cooling circuit.

3. Method according to claim 1, consisting of taking into account the flow rate (D) of the cooling liquid in order to determine the critical temperature (Tc).

4. Method according to claim 1, in which the maximum acceptable intensity (Im) is determined in the control box (19) from tables of numerical values stored in this control box (19), said tables comprising values representing the maximum acceptable current (Im) for different operating conditions.

5. Method according to claim 1, further comprising the step of determining the value representing the flow rate (D) of cooling liquid from the speed (Nt) of a thermal engine of the vehicle and a nomogram characteristic of a water pump driven by this thermal engine, said water pump causing the circulation of the cooling liquid.

6. Method according to claim 5, in which the value signifying the speed of the thermal engine comes from data transmitted by a CAN bus.
